(19) United States
(12) Patent Application Publication
(10) Pub. No.: US 2013/0049647 A1
(43) Pub. Date: Feb. 28, 2013

(54) Force Distribution Method for Stage Systems Utilizing Dual Actuators

(71) Applicant: Pai-Hsueh Yang, Palo Alto, CA (US)

(72) Inventor: Pai-Hsueh Yang, Palo Alto, CA (US)

(73) Assignee: NIKON CORPORATION, Tokyo (JP)

(21) Appl. No.: 13/597,592

(22) Filed: Aug. 29, 2012

Related U.S. Application Data
(60) Provisional application No. 61/528,290, filed on Aug. 29, 2011.

(51) Int. Cl. H02K 41/035

(52) U.S. Cl. 318/135

(57) ABSTRACT

According to one aspect, a method for controlling a stage that is a part of a stage apparatus and is coupled to a voice coil motor (VCM) and an EI-core actuator arrangement includes driving the stage, identifying a frequency associated with the stage, and determining whether the frequency is below a frequency setpoint. The method also includes providing a first control force on the stage using the EI-core actuator arrangement when it is determined that the frequency is below the frequency setpoint, and providing the first control force on the stage using the VCM when it is determined that the frequency is not below the frequency setpoint.

### CROSS REFERENCE TO RELATED APPLICATION

The present application claims benefit under 35 U.S.C. §119(e) of U.S. Provisional Patent Application No. 61/528,290, entitled “Stage Force Distribution Method for Dual Actuators,” filed Aug. 29, 2011, which is incorporated herein by reference in its entirety for all purposes.

### BACKGROUND OF THE INVENTION

1. Field of the Invention

The present invention relates generally to equipment used in semiconductor processing. More particularly, the present invention relates to using dual actuators to apply control forces to a stage such that a selection of whether to use a voice coil motor (VCM) (first actuator) or EI-core actuator (second actuator) to drive the stage is based upon a frequency component associated with the stage.

2. Description of the Related Art

For precision instruments such as photolithography machines which are used in semiconductor processing, factors which affect the performance, e.g., accuracy, of the precision instrument generally must be dealt with and, insofar as possible, eliminated. By way of example, excessive vibrations associated with a stage of a photolithography machine may compromise the performance of the stage. When the performance of a precision instrument such as a wafer stage is adversely affected, products formed using the precision instrument may be improperly formed and, hence, function improperly.

Some wafer stage devices include fine stages which have substantially no mechanical connections to the coarse stages below them. A fine stage or a wafer table which has no mechanical connections to a coarse stage may supported in a z-direction, or vertical direction, by air bearings, such that there are no wires or tubes between the fine stage and the coarse stage. The fine stage is generally driven in planar degrees of freedom with electromagnetic actuators, and is a ceramic box structure which provides a relatively high stiffness. The electromagnetic actuators include a linear motor and a voice coil motor (VCM) that use Lorentz force for generating a driving force. When linear motors or VCMs are used as the actuators to drive the fine stage such that the fine stage accelerates or decelerates, the relatively high amount of heat generated by the actuators may compromise the accuracy with which positioning may occur.

As VCMs are generally characterized by high accuracy but relatively low efficiency, some wafer stage devices utilize VCMs to generate a relatively low force with low electromagnetic stiffness during a high accuracy, constant velocity portion of a scan involving a fine stage while utilizing less accurate but more efficient actuators to generate a relatively high force during acceleration and deceleration. Such wafer stage devices may use electromagnet actuators, for example EI-core or CI-core actuators, which have a relatively high efficiency and generate relatively little heat, during a lower accuracy, accelerating portion of a scan and VCMs during the high accuracy portion of the scan. Electromagnet actuators such as EI-core actuators have a non-constant force as a function of position and, as a result, must be commutated. Any error in commutation will generally manifest itself as a stiffness of the actuator, thereby causing vibration transmission between the coarse stage and the fine stage. As a result, for relatively high accuracy scanning, electromagnet actuators such as EI-core actuators may not be preferred.

Some stage systems may utilize an EI-core actuator solely for feedforward control and only a VCM for feedback control. In a system that utilizes an EI-core actuator substantially only for feedforward control and a VCM substantially only for feedback control, the VCM may require a relatively large force magnitude, e.g., when feedforward control is not optimized or an electromagnet actuator such as an EI-core actuator amplifier bandwidth is not high enough, thereby resulting in significant heat generation.

### SUMMARY OF THE INVENTION

The present invention pertains to applying control forces to a stage using dual actuators such that the choice of which of the dual actuators to use to apply control forces is based upon a frequency component associated with the stage.

According to one aspect, a method for controlling a stage that is a part of a stage apparatus and is coupled to a first actuator (a voice coil motor (VCM)) arrangement and a second actuator (an EI-core actuator) arrangement includes driving the stage, identifying a frequency associated with the stage, and determining whether the frequency is below a frequency setpoint. The method also includes providing a first control force on the stage using the second actuator arrangement when it is determined that the frequency is below the frequency setpoint, and providing the first control force on the stage using the first actuator arrangement when it is determined that the frequency is not below the frequency setpoint. In one embodiment, the method also includes determining whether to provide a feedback force on the stage or a feedforward force on the stage, wherein the feedback force is the first control force and is provided on the stage when it is determined that the feedback force is to be provided.

In accordance with another aspect of the present invention, an apparatus includes a stage and a first driving device arrangement arranged to drive the stage. The apparatus also includes a dual actuator arrangement and a control arrangement. The dual actuator arrangement is configured to apply at least a first control force to the stage, and includes a first actuator (a voice coil motor (VCM)) arrangement and a second actuator (an EI-core actuator) arrangement. The control arrangement is configured to obtain a frequency associated with the stage and to determine when the frequency is below a threshold frequency. The control arrangement is also configured to cause the second actuator arrangement to apply the first control force to the stage when the frequency is below the threshold frequency and to cause the first actuator arrangement to apply the first control force to the stage when the frequency is not below the threshold frequency.

### BRIEF DESCRIPTION OF THE DRAWINGS

The invention will be readily understood by the following detailed description in conjunction with the accompanying drawings, in which:

FIG. 1 is a diagrammatic representation of a stage, e.g., a fine stage, that is driven by EI-core actuators and a voice coil motor (VCM) in accordance with an embodiment of the present invention.

FIG. 2A is a block diagram representation of a system in which a control arrangement may determine whether to use a VCM arrangement or an EI-core actuator arrangement to drive a stage in accordance with an embodiment of the present invention.

FIG. 2B is a block diagram representation of a system in which a control arrangement, e.g., control arrangement 216 of FIG. 2A, includes force distribution modules and may determine whether to use a VCM arrangement or an EI-core actuator arrangement to drive a stage in accordance with an embodiment of the present invention.

FIG. 3 is a block diagram representation of an overall force distribution module, e.g., overall force distribution module 220 of FIG. 2B, in accordance with an embodiment of the present invention.

FIG. 4 is a diagrammatic representation of a stage control block diagram associated with dual actuators in accordance with an embodiment of the present invention.

FIG. 5 is a block diagram representation of an EI-core amplifier pre-filter in accordance with an embodiment of the present invention.

FIG. 6 is a process flow diagram which illustrates a method of configuring a frequency threshold or setpoint of a control system in accordance with an embodiment of the present invention.

FIG. 7 is a process flow diagram which illustrates a first method of applying a control force to a stage in accordance with an embodiment of the present invention.

FIG. 8 is a process flow diagram which illustrates a second method of applying a control force to a stage in accordance with an embodiment of the present invention.

FIG. 9 is a diagrammatic representation of a photolithography apparatus in accordance with an embodiment of the present invention.

FIG. 10 is a process flow diagram which illustrates the steps associated with fabricating a semiconductor device in accordance with an embodiment of the present invention.

FIG. 11 is a process flow diagram which illustrates the steps associated with processing a wafer, i.e., step 1113 of FIG. 10, in accordance with an embodiment of the present invention.

FIG. 12 is a diagrammatic representation of frequency responses associated with a low pass filter, a high pass filter, and a fusion filter that includes both a low pass filter and a high pass filter in accordance with an embodiment of the present invention.

### DETAILED DESCRIPTION OF THE EMBODIMENTS

Example embodiments of the present invention are discussed below with reference to the various figures. However, those skilled in the art will readily appreciate that the detailed description given herein with respect to these figures is for explanatory purposes, as the invention extends beyond these embodiments.

A dual actuator stage system may include a fine wafer stage which is controlled by two different types of actuators including a first actuator and a second actuator. For example the first actuator may be a voice coil motor (VCM) and the second actuator may be an electromagnet actuator such as an EI-core actuator. Together, the different types of actuators may be an overall hybrid servo in which an EI-core actuator operates to provide some control forces to a stage and a VCM provides other control forces to the stage. The choice of which type of actuator to use to provide control forces may be based, in one embodiment, upon a frequency associated with the stage.

In terms of dynamics, a first actuator arrangement such as a VCM is generally more linear than a second actuator arrangement such as an EI-core actuator, and more suitable for use in providing precision control. However, for a particular amount of current, a second actuator arrangement generates more force than generated by a first actuator arrangement. Therefore, to substantially minimize a total current requirement, it may be beneficial to deliver at least a feedforward control force using a second actuator arrangement such as an EI-core actuator).

When a second actuator arrangement, e.g., an EI-core actuator, is well calibrated and becomes more linear, a feedback force distribution frequency for a second actuator arrangement, e.g., the EI-core actuator, may be increased to reduce current needed to a first actuator arrangement, e.g., a VCM). In contrast, when the second actuator arrangement is not well calibrated, the feedback force distribution frequency for the second actuator arrangement may be reduced to improve positioning accuracy. For higher stage throughput, a fine stage utilizes a higher actuator force capacity. While a first actuator, e.g., a VCM, generally has good linearity, a first actuator such as a VCM generally has a lower force constant than a second actuator arrangement, e.g., an EI-core actuator. In contrast, a second actuator arrangement generally has higher a force constant than a first actuator arrangement, but a poorer linearity and a higher inductance load for an amplifier. In one embodiment, a VCM force requirement may be substantially minimized by using an EI-core for feedforward control as well as for feedback control at relatively low frequencies. As both types of actuators, i.e., both EI-core actuators and a VCM, are arranged to be substantially always on and generally do not need to be switched on, there are effectively no force discontinuity issues associated with a fine stage that utilizes both the EI-core actuator and the VCM.

In one embodiment, a frequency threshold or a fusion frequency may be used to determine whether a control force is to be provided using a first actuator arrangement or a second actuator arrangement. In one embodiment, feedforward control forces may be provided by a second actuator arrangement at substantially all times, while feedback control forces may be provided by a second actuator arrangement when a frequency associated with a stage is less than a frequency threshold and by a first actuator arrangement when the frequency is greater than the frequency threshold. In another embodiment, substantially all control forces may be provided by a second actuator arrangement when a frequency associated with a stage is less than the frequency threshold and by a first actuator arrangement when the frequency is greater than the frequency threshold. The fusion frequency associated with a stage may generally be substantially optimized to minimize power consumption of actuators and to minimize stage positioning errors, based on factors including, but not limited to including, frequency components associated with a stage.

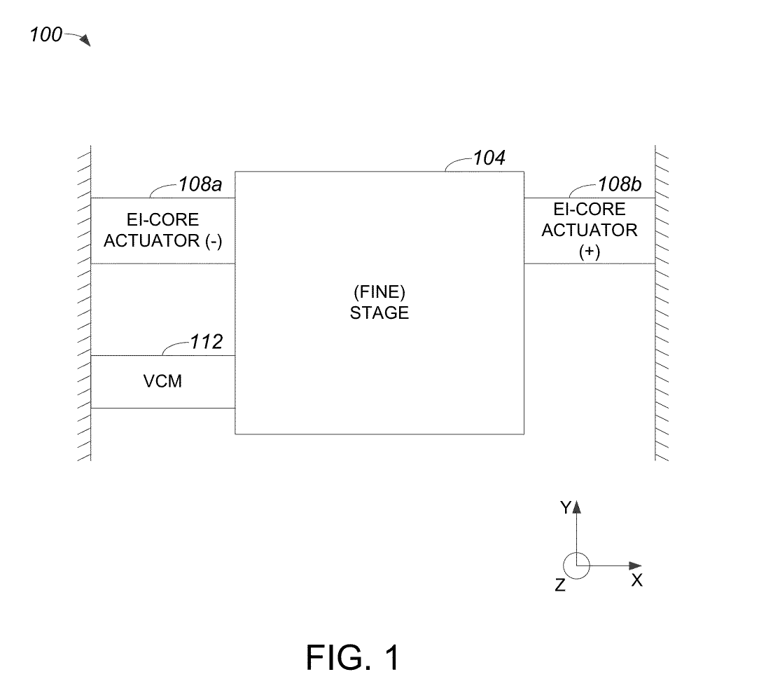

Referring initially to FIG. 1, a stage apparatus which includes a stage that may have control forces imparted thereon by a first actuator arrangement that may be a VCM or a second actuator arrangement that may be an EI-core actuator, depending upon a frequency associated with the stage, will be described in accordance with an embodiment of the present invention. A stage system or apparatus 100, which may be a part of an overall photolithography apparatus, includes a stage 104. Stage 104 may be any suitable stage that is configured to move, e.g., a fine positioning stage that is configured to carry and to position a wafer (not shown). In general, stage 104 may be arranged to move in any number of degrees of freedom, e.g., up to approximately six degrees of freedom.

Stage 104 may be carried on another stage (not shown). For example, if stage 104 is a fine stage, then stage 104 may be carried on a coarse stage (not shown). In the described embodiment, in order to compensate for disturbances on stage 104, control forces may be provided to stage 104 using an EI-core actuator arrangement, or a second actuator arrangement, that includes a first EI-core actuator 108a and a second EI-core actuator 108b, or a VCM 112, or a first actuator arrangement. First EI-core actuator 108a may be arranged to provide a control force in one direction, and second EI-core actuator 108b may be arranged to provide a control force in a second direction. For example, EI-core actuator 108a and EI-core actuator 108b may be configured to provide control forces in opposite directions. It should be appreciated that although an EI-core actuator arrangement is described, other electromagnetic actuators may be utilized in lieu of an EI-core actuator arrangement.

The selection of whether to use one of EI-core actuators 108a, 108b or VCM 112 to impart a control force on stage 104 may be based on the characteristics of a disturbance on stage 104. By way of example, stage 104 may have an associated frequency when stage 104 is subject to vibratory disturbances, and the frequency associated with stage 104 may be used to determine whether to impart a control force on stage 104 using one of EI-core actuators 108a, 108b or VCM 112.

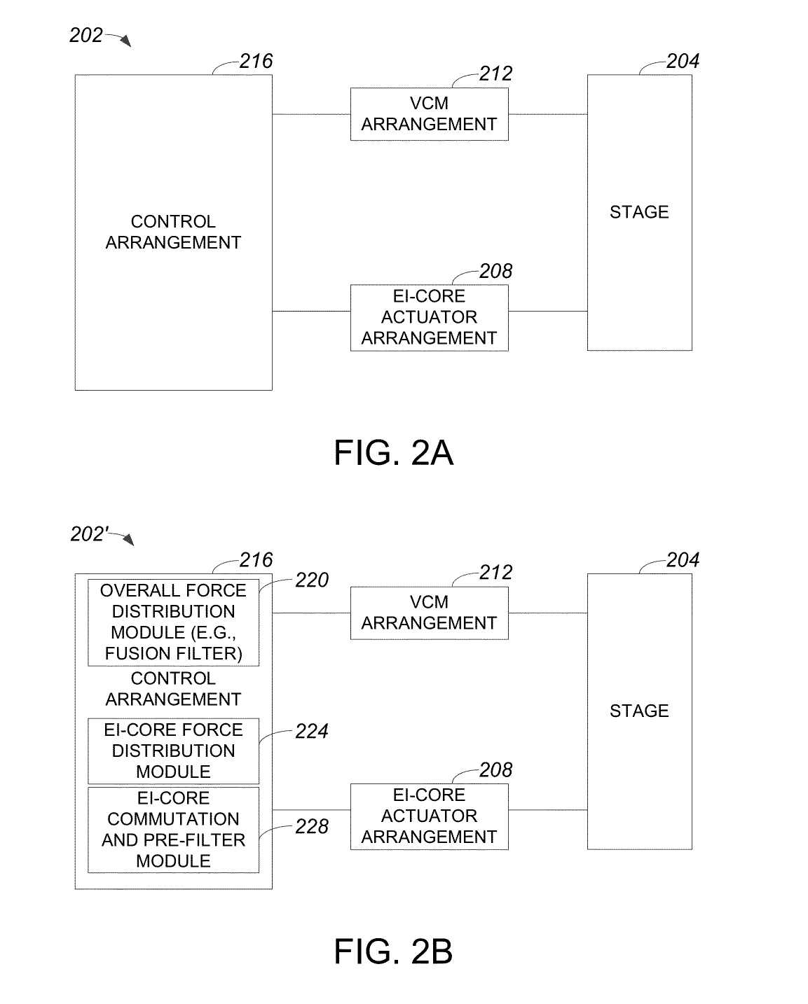

In general, a control arrangement (not shown) is arranged to control the current provided to EI core actuators 108a, 108b and to VCM 112, i.e., to substantially cause control forces to be applied by EI-core actuators 108a, 108b and VCM 112. FIG. 2A is a block diagram representation of a system in which a control arrangement may determine whether to use a VCM arrangement or an EI-core actuator arrangement to drive a stage in accordance with an embodiment of the present invention. A system 202 includes a stage 204, an EI-core actuator arrangement 208, a VCM arrangement 212, and a control arrangement 216. EI-core actuator arrangement 208 may include any number of EI-core actuators (not shown), while VCM arrangement 212 may include at least one VCM (not shown).

Control arrangement 216 is generally configured to determine whether a frequency associated with stage 204 is above or below a threshold frequency or setpoint, and to cause current to be provided to either EI-core actuator arrangement 208 or VCM arrangement 212, depending upon whether the frequency is above or below the threshold frequency. In one embodiment, EI-core actuators (not shown) included in EI-core actuator arrangement 208 and a VCM (not shown) included in VCM arrangement 212 are substantially always “on.” As such, when control arrangement 216 causes current to be provided to EI-core actuator arrangement 208 or to VCM arrangement 212, control forces may be relatively efficiently applied to stage 204. In other words, in terms of power consumption, it is generally more efficient to leave EI-core actuator arrangement 208 and a VCM (not shown) included in VCM arrangement 212 substantially always “on.”

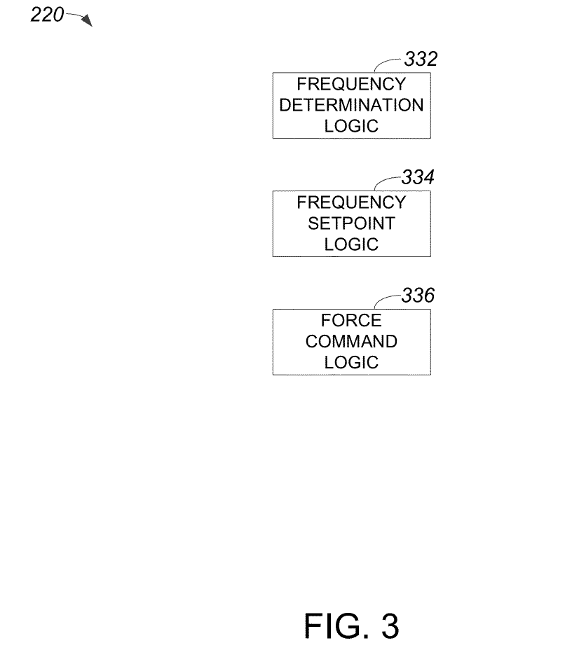

With reference to FIG. 2B, control arrangement 216 will be described in more detail in accordance with an embodiment of the present invention. Within system 202′, control arrangement 216 includes an overall force distribution module 220, an EI-core force distribution module 224, and an EI-core communication and pre-filter module 228. Overall force distribution module 224, which will be described in more detail below with respect to FIG. 3, is configured to determine how much force either VCM arrangement 212 or EI-core actuator arrangement 208 is to apply to stage 204, e.g., how much current to provide to either VCM arrangement 212 or EI-core actuator arrangement 208, to achieve a desired trajectory or position for stage 204. In one embodiment, the amount of force to apply to stage 204 is selected to effectively correct a following error, or a difference between a desired trajectory and an actual stage position. Force distribution module 220 may generally implement a fusion filter that distributes a total force command to either VCM arrangement 212 or to EI-core actuator arrangement 208. In one embodiment, force distribution module 220 may be considered to be a fusion filter.

EI-core force distribution module 224 is configured to communicate with overall force distribution module 220 when overall force distribution module 220 determines that EI-core actuator arrangement 208 is to apply force to stage 204, and may identify an appropriate EI-core actuator included in EI-core actuator arrangement 208 to apply force to stage 204. EI-core communication and pre-filter module 228 obtains a force command from EI-core force distribution module 224, and cooperates with an EI amplifier included in EI-core actuator arrangement 208 to allow the EI amplifier to achieve substantially the same current tracking performance as an amplifier included in VCM arrangement 212. The force command obtained from EI-core force distribution module 224 may generally be expressed as follows:

u_{EI}=F_{EI+}+F_{EI-}

u_{EI} represents a force command to EI-core actuator arrangement 208, while F_{EI+} represents a force to be applied by a first EI-core actuator of EI-core actuator arrangement 208 and F_{EI-} represents a force to be applied by a second EI-core actuator of EI-core actuator arrangement 208.

A force to be applied by an EI-core actuator, e.g., F_{EI}, is a function of a gap distance (g) between a coil and a magnet of the EI-core actuator, a constant (k_{EI}), and a current (I_{EI}). F_{EI} may be expressed as follows:

$${F}_{EI} = {k}_{EI} ( \frac{{I}_{EI}^{2}}{{g}^{2}} )$$

Similarly, a current provided to an EI-core actuator may be expressed as follows:

$${I}_{EI} = \sqrt{\frac{{F}_{EI}}{{k}_{EI}}} g$$

FIG. 3 is a block diagram representation of an overall force distribution module, e.g., overall force distribution module 220 of FIG. 2B, in accordance with an embodiment of the present invention. Overall force distribution module 220 generally includes logic, e.g., hardware logic and/or software logic. The logic may generally implement a fusion filter that distributes a total force command to a VCM and/or to EI-core actuators. In one embodiment, overall force distribution module 220 may implement a fusion filter through frequency determination logic 332, frequency setpoint logic 332, and force command logic 336.

Frequency determination logic 332 is configured to determine a frequency associated with a stage, e.g., a vibrational frequency that arises when the stage is driven, substantially in real-time. Frequency determination logic 332 may include a sensing arrangement (not shown) that effectively measures frequency components associated with a stage.

Frequency setpoint logic 334 is configured to obtain a frequency threshold, e.g., fusion frequency or setpoint, and to effectively set the frequency threshold as a parameter within overall force distribution module 220. The frequency threshold may generally vary widely depending upon, but not limited to depending upon, the requirements and characteristics of an overall stage system. By way of example, the frequency threshold may vary based upon the characteristics of actuators, characteristics of an EI amplifier, whether a control loop is closed-loop or open-loop, and/or acceptable stage following errors.

In general, if a frequency threshold is relatively low, most feedback control forces may be provided by a VCM arrangement, while if a frequency threshold is relatively high, most feedback and feedforward control forces may be provided by an EI-core actuator arrangement. It should be appreciated that the frequency threshold may be any suitable frequency, as for example a frequency in a range between approximately one Hertz (Hz) and approximately 1000 Hz. Typically, for a given overall system, an appropriate frequency, e.g., an appropriate fusion frequency, may be selected to substantially provide for a relatively low stage-following error with relatively small power consumption. Further, the frequency threshold may also vary based on whether both feedback control forces and feedforward control forces are separated, or substantially only feedback control forces are separated. That is, the frequency threshold may vary depending upon whether hybrid total control or hybrid feedback control is implemented.

Force command logic 336 is configured to determine whether to provide a force command to a VCM arrangement, or whether to provide a force command to an EI-core actuator arrangement. In general, force command logic 336 may compare a relatively current, or measured, frequency determined using frequency determination logic 332 to the frequency setpoint. In addition, force command logic 336 is also configured to provide a force command after determining whether to provide the force command to a VCM arrangement or to an EI-core actuator arrangement.

When hybrid feedback control is used, force command logic 336 may cause substantially all feedforward control forces to be provided by an EI-core actuator arrangement, and may determine whether to provide feedback control forces to an EI-core actuator arrangement or to a VCM arrangement depending upon whether the current frequency is above or below the frequency setpoint. In one embodiment, the force commands to an EI-core arrangement and to a VCM arrangement when hybrid feedback control is used may be expressed as follows:

u_{EI}(s)=H_{low}_{_{—}}ₚₐₛₛ(s)·u_{FB}(s)

u_{VCM}(s)=(1−H_{low}_{_{—}}ₚₐₛₛ(s))·u_{FB}(s)

u_{EI} represents a force command to an EI-core actuator arrangement, u_{VCM} represents a force command to a VCM arrangement, u_{FB} represents a feedback force command, H_{low-pass} represents a low-pass filter, and (1−H_{low-pass}) represents a high-pass filter. As will be appreciated by those skilled in the art, a low-pass filter allows lower frequency components to pass through the low-pass filter, whereas a high-pass filter allows higher frequency components to pass through the high-pass filter.

In lieu of hybrid feedback control, hybrid total control may be used. For hybrid total control, command logic 336 may determine whether to provide substantially all control forces to an EI-core actuator arrangement or to a VCM arrangement depending upon whether the current frequency is above or below the frequency setpoint. In one embodiment, the total force commands to an EI-core arrangement and to a VCM arrangement based on frequency components when hybrid total control is used may be expressed as follows:

$$( \begin{matrix}{u}_{EI} \\ {u}_{VCM}\end{matrix} ) = ( \begin{matrix}{H}_{low \_ pass} ( s ) \\ 1 - {H}_{low \_ pass} ( s )\end{matrix} ) \cdot ( {u}_{FB} + {u}_{FF} )$$

u_{EI} represents a force command to an EI-core actuator arrangement, u_{VCM} represents a force command to a VCM arrangement, u_{FB} represents a feedback force command, u_{FF} represents a feedforward force command, H_{low-pass} represents a low-pass filter, and (1-H_{low-pass}) represents a high-pass filter.

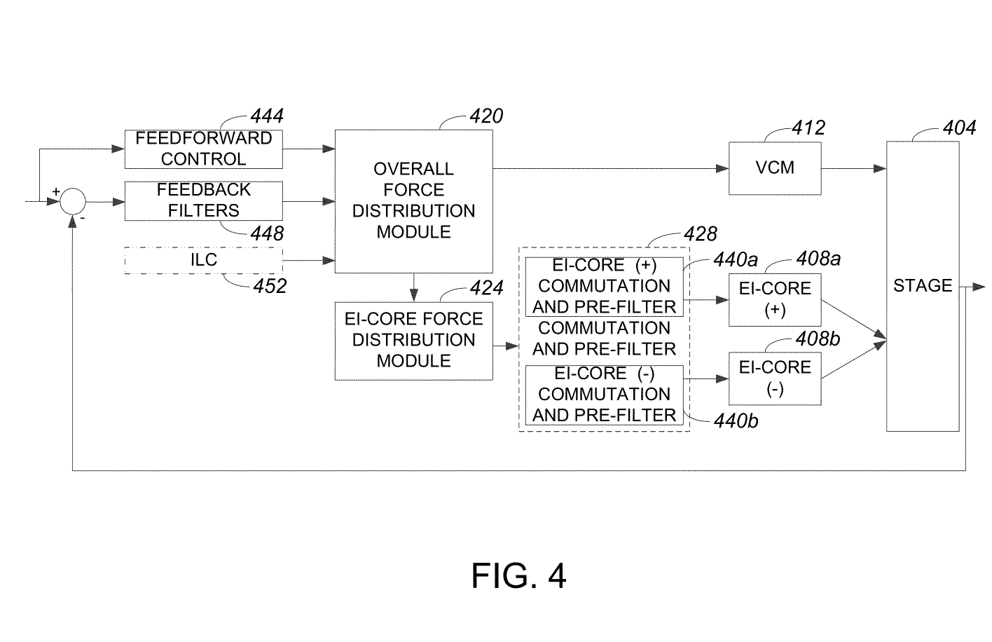

FIG. 4 is a diagrammatic representation of a stage control block diagram associated with dual actuators in accordance with an embodiment of the present invention. A VCM 412, a first EI-core actuator 408a, and a second EI-core actuator 408b are each arranged to apply a control force to a stage 404, which may be a fine stage. In one embodiment, first EI-core actuator 408a is configured to apply a control force in a first direction and second EI-core actuator 408b is configured to apply a control force in a second direction, as for example a direction that is opposite to the first direction.

An overall force distribution module 420 communicates substantially directly with VCM 412 to provide force commands to VCM 412, and to cause current to be provided to VCM 412. Overall force distribution module 420 also communicates with an EI-core force distribution module 424 to provide force commands substantially indirectly to first EI-core actuator arrangement 408a and second EI-core actuator arrangement 408b. EI-core force distribution module 424 which communicates with a commutation and pre-filter arrangement 428. Commutation and pre-filter arrangement 428 includes an EI-core commutation and pre-filter 440a associated with first EI-core actuator 408a, and an EI-core commutation and pre-filter 440b associated with second EI-core actuator 408b. In one embodiment, a low-pass feedback force may be distributed by overall force distribution module 420 to EI-core force distribution module 424 and residual feedback forces may be distributed to VCM 412.

As shown, overall force distribution module 420 obtains signals from a feedforward controller 444, feedback filters 448, and an optional iterative learning controller (ILC) 452. In one embodiment, ILC 452 may effectively serve as a feedforward controller or a feedback controller in terms of force distribution, as an effective learning frequency of ILC 452 may generally be higher than a closed-loop feedback control bandwidth.

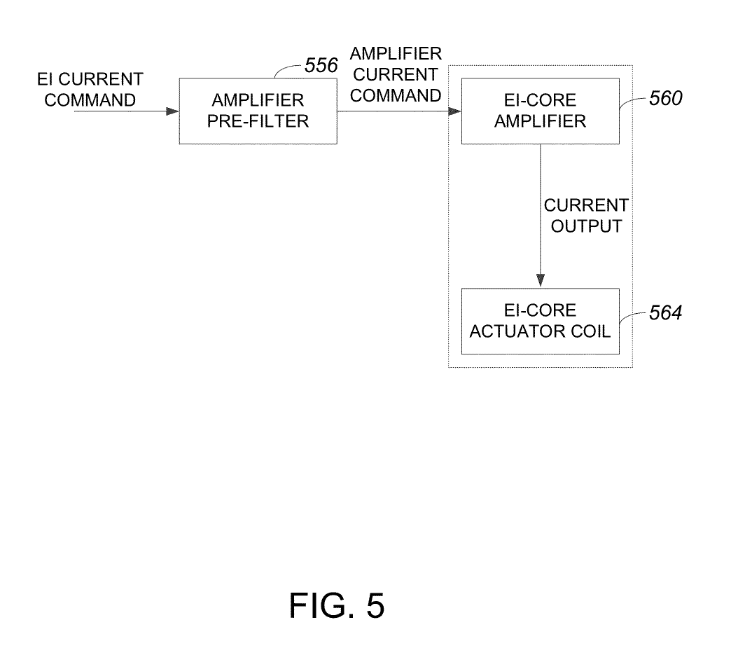

FIG. 5 is a block diagram representation of an EI-core amplifier pre-filter in accordance with an embodiment of the present invention. An EI amplifier pre-filter 556 is configured to receive or otherwise obtain a current command, as for example from a control arrangement such as control arrangement 216 of FIGS. 2A and 2B. Amplifier pre-filter 556 is generally configured to enable an EI-core amplifier 560 to achieve substantially the same current tracking performance as an amplifier for a VCM. As such, the use of amplifier pre-filter 556, in addition to an amplifier for a VCM, allows a stage (not shown) that is controlled, as for example servoed, to achieve substantially the same closed-loop bandwidth whether the stage is controlled by a VCM or by an EI-core actuator.

Amplifier pre-filter 556 processes the obtained current command, and provides an amplified current command to EI-core amplifier 560. EI-core amplifier, in turn, provides an output current to a coil 564 of an EI-core actuator.

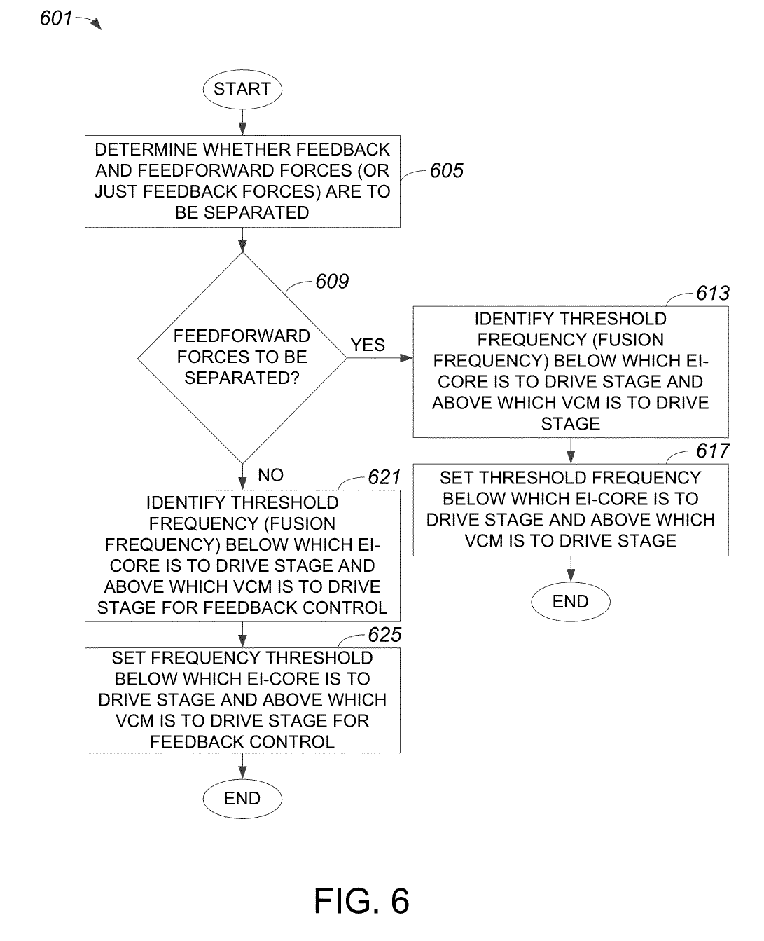

In general, a threshold frequency or fusion frequency may vary depending upon overall system requirements and/or characteristics. For example, a threshold frequency may be selected based, at least in part, upon the size of a VCM in the system and the amount of heat generated by the VCM. Typically, a suitable threshold frequency may be determined and may be set by control design engineers who configure an overall system. FIG. 6 is a process flow diagram which illustrates a method of configuring a threshold frequency or a setpoint of a control system of a stage apparatus in accordance with an embodiment of the present invention. A process 601 of configuring a threshold frequency or a setpoint begins at step 605 in which it is determined whether both feedback and feedforward forces are to be separated. In other words, it is determined whether a stage is to be controlled using hybrid total control. Feedback forces are generally separated, or are such that a determination of whether to provide feedback forces to a stage using a VCM or EI-core actuators is based upon a frequency associated with the stage, and that feedforward forces may be separated. Feedforward forces, on the other hand, may either be separated or substantially always be provided by EI-core actuators.

If it is determined in step 609 that feedforward forces are to be separated, e.g., that hybrid total control is to be implemented, the indication is that a frequency threshold is to be set with respect to both feedback and feedforward forces. As such, process flow moves from step 609 to step 613 in which a threshold frequency or a setpoint is identified. The threshold frequency or setpoint is the frequency below which an EI-core actuator is to provide a control force on a stage, and above which a VCM is to provide a control force on the stage. In one embodiment, an EI-core actuator may be configured to provide a control force on the stage at the threshold frequency. In another embodiment, a VCM may be configured to provide a control force on the stage at the threshold frequency. A threshold frequency may be determined based upon factors including, but not limited to including, system characteristics and/or system requirements. After the threshold frequency is identified, the threshold frequency is effectively set in step 617. By way of example, the threshold frequency may be set as a parameter in a control system of a stage apparatus by a user. Once the threshold frequency is set, the process of configuring a threshold frequency is completed.

Returning to step 609, if feedforward forces are not to be separated, the implication is that hybrid feedback control is to be implemented. That is, if feedforward forces are not to be separated, then substantially only feedback forces are to be separated. Accordingly, process flow moves from step 609 to step 621 in which a threshold frequency below which an EI-core actuator is to provide a feedback control force on a stage and above which a VCM is to provide a feedback control force on the stage. Once the threshold frequency is identified, the threshold frequency is set in step 625, and the process of configuring a threshold frequency is completed.

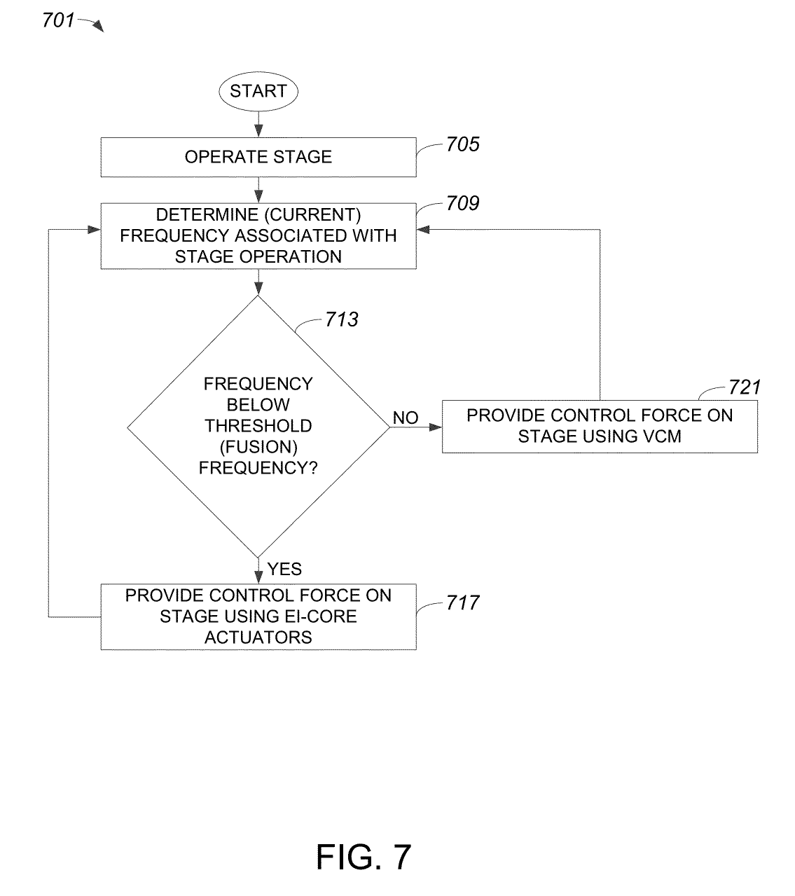

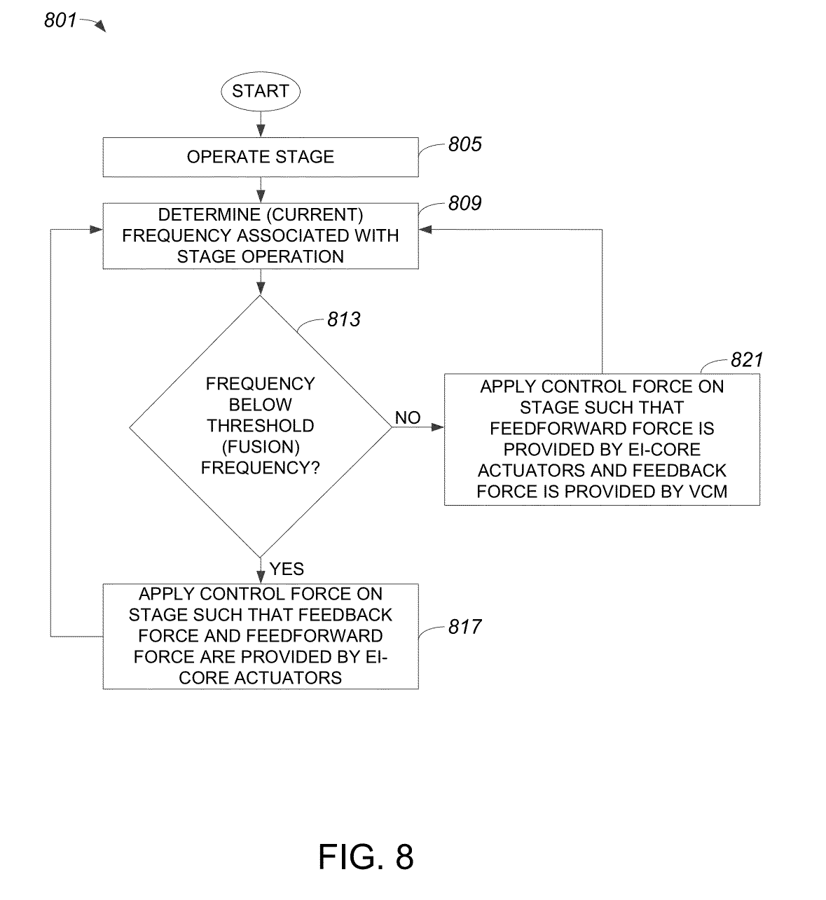

As previously mentioned, a stage that is controlled at least in part by dual actuators may be subject to either hybrid total control or hybrid feedback control. A system in which hybrid total control is impart control forces on a stage will be discussed with reference to FIG. 7, and a system in which hybrid feedback control is used to impart control forces on a stage will be discussed with reference to FIG. 8.

FIG. 7 is a process flow diagram which illustrates a method of applying a control force, e.g., a feedforward force or a feedback force, to a stage using a hybrid total control arrangement in accordance with an embodiment of the present invention. A method 701 of applying force to a stage using EI-core actuators and a VCM that are controlled using hybrid total control begins at step 705 in which the stage operates, e.g., is driven. In one embodiment, the stage may be a fine stage.

A frequency component, e.g., a vibrational frequency or a frequency of vibration, associated with the operation of the stage is determined in step 709. It should be appreciated that the frequency component may be one of many frequency components associated with the operation of the stage. In one embodiment, a current frequency may be determined in substantially real time, e.g., using sensing arrangements configured to perform measurements on the stage.

A determination is made in step 713 as to whether the frequency component, or the current frequency, is below the threshold frequency or setpoint. In general, the frequency identified in step 709 may be compared to the threshold frequency or setpoint. If it is determined that the frequency is below the threshold frequency, then process flow moves to step 717 in which a control force is applied to the stage, e.g., to actuate the stage, using an EI-core actuator. In the described embodiment, both feedback and feedforward forces are provided using an EI-core actuator. It should be appreciated that the selection of which EI-core actuator of a plurality of EI-core actuators to use to provide control forces to the stage based on the frequency may be based on a variety of factors including, but not limited to including, the direction in which the stage is to be driven. From step 717, process flow returns to step 709 in which a current frequency associated with the operation of the stage is determined.

Alternatively, if the determination in step 713 is that the frequency is not below the threshold frequency, then a control force is applied to the stage based on the frequency using the VCM in step 721. Process flow then returns to step 709 in which a current frequency associated with the operation of the stage is determined.

Referring next to FIG. 8, a method of applying a control force to a stage using a hybrid feedback control arrangement will be described in accordance with an embodiment of the present invention. A method 801 of applying force to a stage using EI-core actuators and a VCM that are controlled using hybrid feedback control begins at step 805 in which the stage operates, e.g., is actuated or driven. In one embodiment, the stage may be a fine stage that is effectively driven when a coarse stage with which the fine stage is associated is driven.

A frequency component, e.g., a vibrational frequency which arises when a stage is driven, is identified or otherwise determined in step 809. In one embodiment, a current frequency may be determined in substantially real time, e.g., using sensing arrangements configured to perform measurements on the stage. The frequency component may be, in some situations, one component of a plurality of frequency components associated with the operation of the stage.

A determination is made in step 813 as to whether the frequency is below the threshold frequency or setpoint. If it is determined that the frequency is below the threshold frequency, then process flow moves to step 817 in which a control force is applied to the stage, using an EI-core actuator. In the described embodiment, both feedback and feedforward forces are provided using an EI-core actuator when the frequency is below the threshold frequency. It should be appreciated that the selection of which EI-core actuator of a plurality of EI-core actuators to use to provide control forces the stage may be based on a variety of factors including, but not limited to including, the direction in which the stage is to be driven. From step 817, process flow returns to step 809 in which a current frequency associated with the operation of the stage is determined.

Alternatively, if the determination in step 813 is that the frequency is not below the threshold frequency, then control forces are applied to the stage using either the EI-core actuators or the VCM in 821. When the control force to be applied is a feedforward force, the feedforward force may be provided by the EI-core actuators. When the control force to be applied is a feedback force, the feedback force may be provided by the VCM. After the control force is applied to the stage in step 821, process flow returns to step 809 in which a current frequency associated with the operation of the stage is determined.

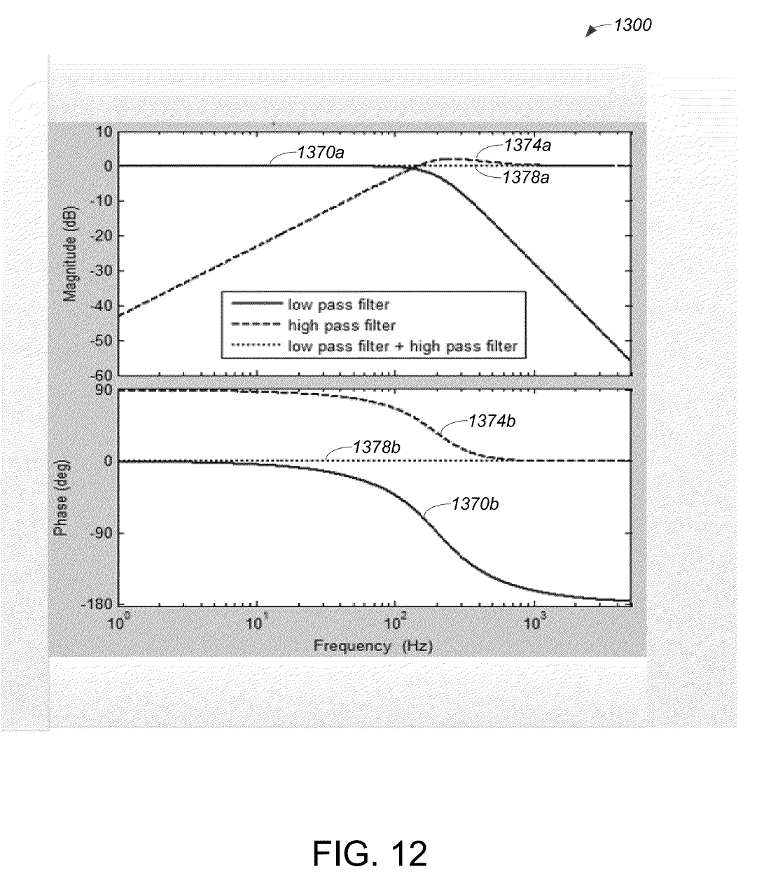

FIG. 12 is a diagrammatic representation of an example of frequency responses associated with different filters arranged to allow control forces to be distributed to either an EI-core actuator or a VCM in accordance with an embodiment of the present invention. A frequency response graphical representation 1300 depicts frequency responses associated with a different filters, e.g., different filters associated with an approximately 200 Hz fusion frequency. When a filter is a low pass filter, a contour 1370a depicts a response based on a magnitude, and a contour 1370b depicts a response based on a phase. When a filter is a high pass filter, a contour 1374a depicts a response based on a magnitude and a contour 1374b depicts a response based on a phase. Finally, when a filter is a fusion filter that incorporates both a high pass filter and a low pass filter, a contour 1378a depicts a response based on a magnitude and a contour 1378b depicts a response based on a phase.

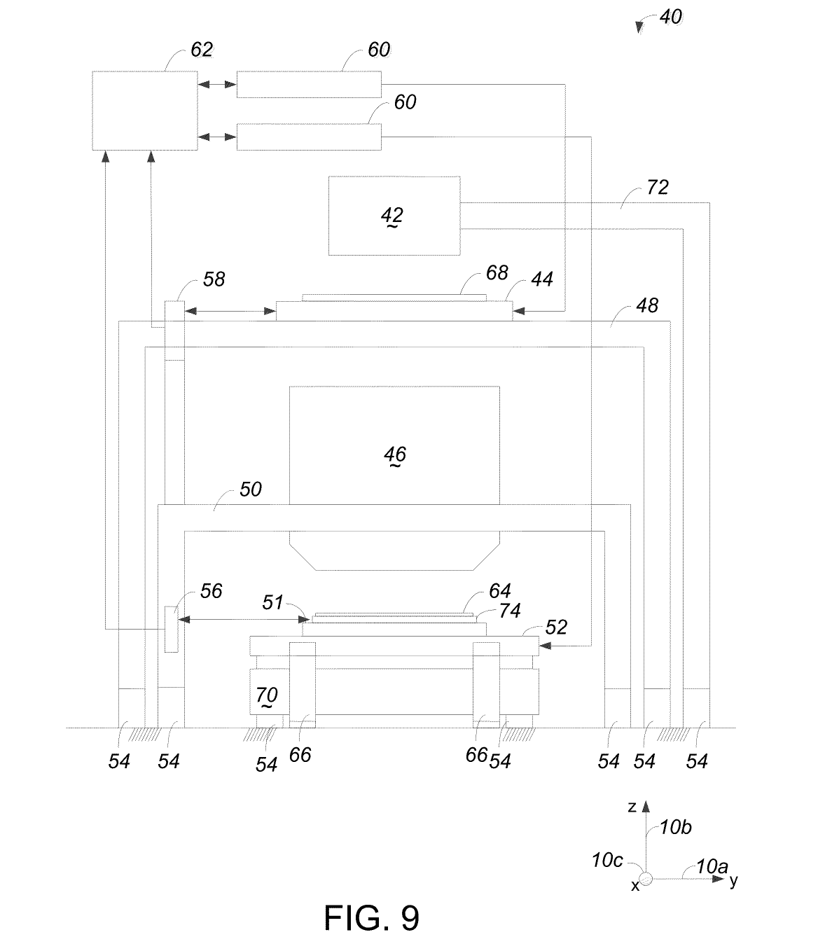

With reference to FIG. 9, a photolithography apparatus which may include a fine stage that utilizes a hybrid feedback control distributed to an EI core and a VCM according to frequency content will be described in accordance with an embodiment of the present invention. A photolithography apparatus (exposure apparatus) 40 includes a wafer positioning stage 52 that may be driven by a planar motor (not shown), as well as a wafer table 51 that is magnetically coupled to wafer positioning stage 52 by utilizing an EI-core actuator. In this case, the planar motor is one a first actuator arrangement, as described above, which drives wafer positioning stage 52 generally uses an electromagnetic force generated by magnets and corresponding armature coils arranged in two dimensions.

A wafer 64 is held in place on a wafer holder or chuck 74 which is coupled to wafer table 51. Wafer positioning stage 52 is arranged to move in multiple degrees of freedom, e.g., in up to six degrees of freedom, under the control of a control unit 60 and a system controller 62. In one embodiment, wafer positioning stage 52 may include a plurality of actuators and have a configuration as described above. The movement of wafer positioning stage 52 allows wafer 64 to be positioned at a desired position and orientation relative to a projection optical system 46.

Wafer table 51 may be levitated in a z-direction 10b by any number of voice coil motors (not shown), e.g., three voice coil motors. In one described embodiment, at least three magnetic bearings (not shown) couple and move wafer table 51 along a y-axis 10a. The motor array of wafer positioning stage 52 is typically supported by a base 70. Base 70 is supported to a ground via isolators 54. Reaction forces generated by motion of wafer stage 52 may be mechanically released to a ground surface through a frame 66. One suitable frame 66 is described in JP Hei 8-166475 and U.S. Pat. No. 5,528,118, which are each herein incorporated by reference in their entireties.

An illumination system 42 is supported by a frame 72. Frame 72 is supported to the ground via isolators 54. Illumination system 42 includes an illumination source, which may provide a beam of light that may be reflected off of a reticle. In one embodiment, illumination system 42 may be arranged to project a radiant energy, e.g., light, through a mask pattern on a reticle 68 that is supported by and scanned using a reticle stage 44 which may include a coarse stage and a fine stage, or which may be a single, monolithic stage. The radiant energy is focused through projection optical system 46, which is supported on a projection optics frame 50 and may be supported the ground through isolators 54. Suitable isolators 54 include those described in JP Hei 8-330224 and U.S. Pat. No. 5,874,820, which are each incorporated herein by reference in their entireties.

A first interferometer 56 is supported on projection optics frame 50, and functions to detect the position of wafer table 51. Interferometer 56 outputs information on the position of wafer table 51 to system controller 62. In one embodiment, wafer table 51 has a force damper which reduces vibrations associated with wafer table 51 such that interferometer 56 may accurately detect the position of wafer table 51. A second interferometer 58 is supported on projection optical system 46, and detects the position of reticle stage 44 which supports a reticle 68. Interferometer 58 also outputs position information to system controller 62.

It should be appreciated that there are a number of different types of photolithographic apparatuses or devices. For example, photolithography apparatus 40, or an exposure apparatus, may be used as a scanning type photolithography system which exposes the pattern from reticle 68 onto wafer 64 with reticle 68 and wafer 64 moving substantially synchronously. In a scanning type lithographic device, reticle 68 is moved perpendicularly with respect to an optical axis of a lens assembly (projection optical system 46) or illumination system 42 by reticle stage 44. Wafer 64 is moved perpendicularly to the optical axis of projection optical system 46 by a wafer stage 52. Scanning of reticle 68 and wafer 64 generally occurs while reticle 68 and wafer 64 are moving substantially synchronously.

Alternatively, photolithography apparatus or exposure apparatus 40 may be a step-and-repeat type photolithography system that exposes reticle 68 while reticle 68 and wafer 64 are stationary, i.e., at a substantially constant velocity of approximately zero meters per second. In one step and repeat process, wafer 64 is in a substantially constant position relative to reticle 68 and projection optical system 46 during the exposure of an individual field. Subsequently, between consecutive exposure steps, wafer 64 is consecutively moved by wafer positioning stage 52 perpendicularly to the optical axis of projection optical system 46 and reticle 68 for exposure. Following this process, the images on reticle 68 may be sequentially exposed onto the fields of wafer 64 so that the next field of semiconductor wafer 64 is brought into position relative to illumination system 42, reticle 68, and projection optical system 46.

It should be understood that the use of photolithography apparatus or exposure apparatus 40, as described above, is not limited to being used in a photolithography system for semiconductor manufacturing. For example, photolithography apparatus 40 may be used as a part of a liquid crystal display (LCD) photolithography system that exposes an LCD device pattern onto a rectangular glass plate or a photolithography system for manufacturing a thin film magnetic head.

The illumination source of illumination system 42 may be g-line (436 nanometers (nm)), i-line (365 nm), a KrF excimer laser (248 nm), an ArF excimer laser (193 nm), and an F2-type laser (157 nm). Alternatively, illumination system 42 may also use charged particle beams such as x-ray and electron beams. For instance, in the case where an electron beam is used, thermionic emission type lanthanum hexaboride (LaB6) or tantalum (Ta) may be used as an electron gun. Furthermore, in the case where an electron beam is used, the structure may be such that either a mask is used or a pattern may be directly formed on a substrate without the use of a mask.

With respect to projection optical system 46, when far ultra-violet rays such as an excimer laser are used, glass materials such as quartz and fluorite that transmit far ultra-violet rays is preferably used. When either an F2-type laser or an x-ray is used, projection optical system 46 may be either catadioptric or refractive (a reticle may be of a corresponding reflective type), and when an electron beam is used, electron optics may comprise electron lenses and deflectors. As will be appreciated by those skilled in the art, the optical path for the electron beams is generally in a vacuum.

In addition, with an exposure device that employs vacuum ultra-violet (VUV) radiation of a wavelength that is approximately 200 nm or lower, use of a catadioptric type optical system may be considered. Examples of a catadioptric type of optical system include, but are not limited to, those described in Japan Patent Application Disclosure No. 8-171054 published in the Official gazette for Laid-Open Patent Applications and its counterpart U.S. Pat. No. 5,668,672, as well as in Japan Patent Application Disclosure No. 10-20195 and its counterpart U.S. Pat. No. 5,835,275, which are all incorporated herein by reference in their entireties. In these examples, the reflecting optical device may be a catadioptric optical system incorporating a beam splitter and a concave minor. Japan Patent Application Disclosure (Hei) No. 8-334695 published in the Official gazette for Laid-Open Patent Applications and its counterpart U.S. Pat. No. 5,689,377, as well as Japan Patent Application Disclosure No. 10-3039 and its counterpart U.S. Pat. No. 5,892,117, which are all incorporated herein by reference in their entireties. These examples describe a reflecting-refracting type of optical system that incorporates a concave minor, but without a beam splitter, and may also be suitable for use with the present invention.

The present invention may be utilized, in one embodiment, in an immersion type exposure apparatus if suitable measures are taken to accommodate a fluid. For example, PCT patent application WO 99/49504, which is incorporated herein by reference in its entirety, describes an exposure apparatus in which a liquid is supplied to a space between a substrate (wafer) and a projection lens system during an exposure process. Aspects of PCT patent application WO 99/49504 may be used to accommodate fluid relative to the present invention.

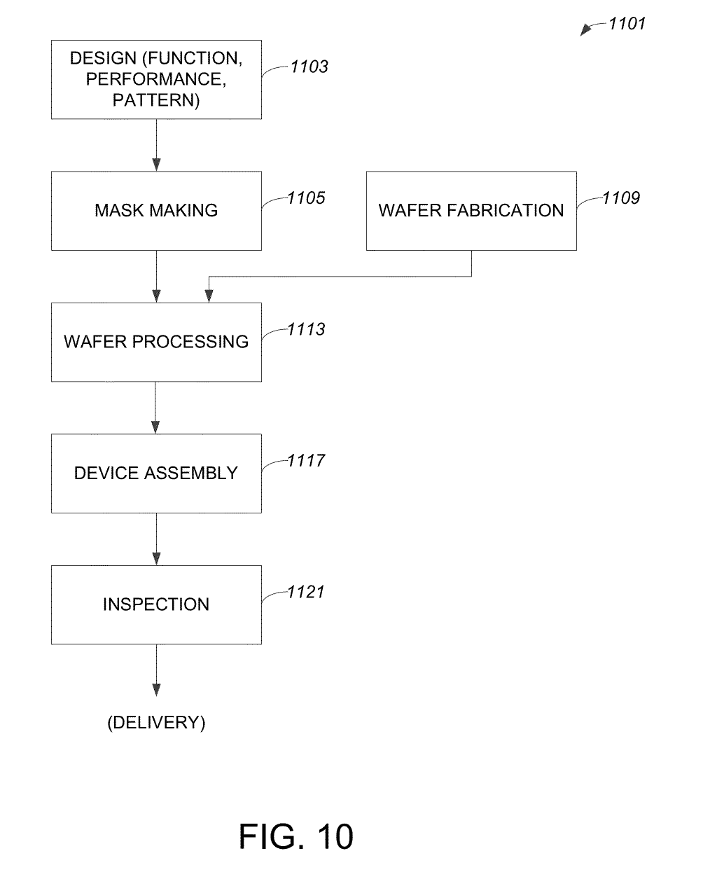

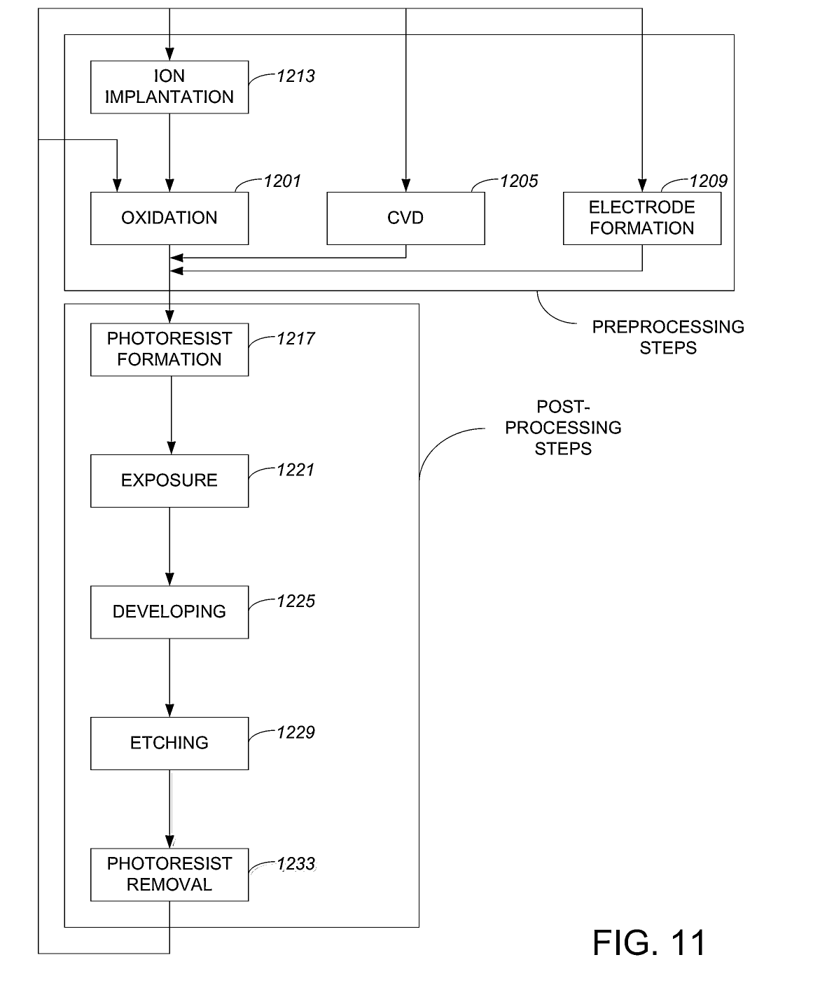

Further, semiconductor devices may be fabricated using systems described above, as will be discussed with reference to FIG. 10. FIG. 10 is a process flow diagram which illustrates the steps associated with fabricating a semiconductor device in accordance with an embodiment of the present invention. A process 1101 of fabricating a semiconductor device begins at step 1103 in which the function and performance characteristics of a semiconductor device are designed or otherwise determined. Next, in step 1105, a reticle or mask in which has a pattern is designed based upon the design of the semiconductor device. It should be appreciated that in a substantially parallel step 1109, a wafer is typically made from a silicon material. In step 1113, the mask pattern designed in step 1105 is exposed onto the wafer fabricated in step 1109. One process of exposing a mask pattern onto a wafer will be described below with respect to FIG. 11. In step 1117, the semiconductor device is assembled. The assembly of the semiconductor device generally includes, but is not limited to including, wafer dicing processes, bonding processes, and packaging processes. Finally, the completed device is inspected in step 1121. Upon successful completion of the inspection in step 1121, the completed device may be considered to be ready for delivery.

FIG. 11 is a process flow diagram which illustrates the steps associated with wafer processing in the case of fabricating semiconductor devices in accordance with an embodiment of the present invention. In step 1201, the surface of a wafer is oxidized. Then, in step 1205 which is a chemical vapor deposition (CVD) step in one embodiment, an insulation film may be formed on the wafer surface. Once the insulation film is formed, then in step 1209, electrodes are formed on the wafer by vapor deposition. Then, ions may be implanted in the wafer using substantially any suitable method in step 1213. As will be appreciated by those skilled in the art, steps 1201-1213 are generally considered to be preprocessing steps for wafers during wafer processing. Further, it should be understood that selections made in each step, e.g., the concentration of various chemicals to use in forming an insulation film in step 1205, may be made based upon processing requirements.

At each stage of wafer processing, when preprocessing steps have been completed, post-processing steps may be implemented. During post-processing, initially, in step 1217, photoresist is applied to a wafer. Then, in step 1221, an exposure device may be used to transfer the circuit pattern of a reticle to a wafer. Transferring the circuit pattern of the reticle of the wafer generally includes scanning a reticle scanning stage which may, in one embodiment, include a force damper to dampen vibrations.

After the circuit pattern on a reticle is transferred to a wafer, the exposed wafer is developed in step 1225. Once the exposed wafer is developed, parts other than residual photoresist, e.g., the exposed material surface, may be removed by etching in step 1229. Finally, in step 1233, any unnecessary photoresist that remains after etching may be removed. As will be appreciated by those skilled in the art, multiple circuit patterns may be formed through the repetition of the preprocessing and post-processing steps.

Although only a few embodiments of the present invention have been described, it should be understood that the present invention may be embodied in many other specific forms without departing from the spirit or the scope of the present invention. By way of example, while a stage that may have control forces applied thereon by dual actuators has been described as being a fine stage, substantially any suitable stage may be driven by dual actuators.

In one embodiment, a fine or precision stage that has feedback and/or feedforward control forces applied to it using a first actuator arrangement such as a VCM arrangement or a second actuator arrangement such as an EI-core actuator, depending upon a frequency associated with the fine stage, may be substantially carried by a coarse stage. Thus, when the coarse stage is driven, the fine stage is also effectively driven as the fine stage is carried by the coarse stage. Vibrations associated with the fine stage, e.g., vibrations which arise when the coarse stage is driven, may be compensated for using feedback and/or feedforward control forces applied substantially directly to the fine stage using a first actuator arrangement or a second actuator arrangement, as appropriate.

While an EI-core actuator arrangement has generally been described as including two EI-core actuators as a second actuator arrangement, it should be appreciated that the number of EI-core actuators included in an EI-core actuator arrangement may vary widely. For example, an EI-core actuator arrangement may include a single EI-core actuator, or may include multiple EI-core actuators without departing from the spirit or the scope of the embodiments. In one embodiment, in lieu of an EI-core actuator arrangement, a CI-core actuator arrangement that includes one or more CI-core actuators may be used without departing from the spirit or the scope of this disclosure.

An EI-core commutation and pre-filter module has been described as being a part of a control arrangement. It should be appreciated, however, that EI-core commutation and pre-filter module may instead be a part of an EI-core actuator arrangement.

Hybrid feedback control may flexibly utilize the advantages of both an EI-core actuator and a VCM while maintaining a relatively low VCM force requirement. With a lower fusion frequency, such a hybrid servo functions more similarly to a VCM servo. In contrast, with a higher fusion frequency, such a hybrid servo functions more similarly to an EI-core servo.

In one embodiment, EI-core actuators and a VCM are both substantially always on while a stage is in use. Therefore, force discontinuity issues may effectively be minimized, as EI-core actuators and a VCM do not need to be switched on.

Generally, a control arrangement may be implemented using hardware components and/or logic. The modules included in a control arrangement, e.g., control arrangement 216 of FIGS. 2A and 2B, may be software components that include software logic embodied in a tangible, i.e., non-transitory, medium that, when executed, is operable to perform the various methods and processes described above. That is, the logic may be embodied as physical arrangements, modules, or components. A tangible medium may be substantially any computer-readable medium that is capable of storing logic or computer program code which may be executed, e.g., by a processor or an overall computing system, to perform methods and functions associated with the embodiments. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

The steps associated with the methods discussed above may vary widely. Steps may be added, removed, altered, combined, and reordered without departing from the spirit of the scope of the present disclosure. Therefore, the present examples are to be considered as illustrative and not restrictive, and the examples is not to be limited to the details given herein, but may be modified within the scope of the appended claims.

The many features of the embodiments of the present invention are apparent from the written description. Further, since numerous modifications and changes will readily occur to those skilled in the art, the present invention should not be limited to the exact construction and operation as illustrated and described. Hence, all suitable modifications and equivalents may be resorted to as falling within the spirit or the scope of the present invention.

What is claimed is:

1. A method for controlling a stage, the stage being part of a stage apparatus, the stage being coupled to a first actuator arrangement and a second actuator arrangement, the method comprising:
driving the stage;
identifying a frequency associated with the stage;
determining whether the frequency is below a frequency setpoint;
providing a first control force on the stage using the second actuator arrangement when it is determined that the frequency is below the frequency setpoint; and
providing the first control force on the stage using the first actuator arrangement when it is determined that the frequency is not below the frequency setpoint.

2. The method of claim 1 wherein the first control force is a feedback force.

3. The method of claim 1 further including:
determining whether to provide a feedback force on the stage or a feedforward force on the stage, the feedback force being the first control force, wherein the first control force is provided on the stage when it is determined that the feedback force is to be provided.

4. The method of claim 3 wherein when it is determined that the feedforward force is to be provided on the stage, the method further includes:
providing the feedforward force on the stage using the second actuator arrangement.

5. The method of claim 1 wherein the first control force is a feedforward force.

6. The method of claim 1 wherein the frequency is associated with a vibration, the vibration arising when driving the stage.

7. The method of claim 1 wherein the second actuator arrangement is on when the first control force is provided using the first actuator arrangement, and wherein and the first actuator is on when the first control force is provided using the second actuator arrangement.

8. The method of claim 1 wherein the first actuator arrangement includes a voice coil motor (VCM) and the second actuator arrangement includes an EI-core actuator.

9. The method of claim 1 wherein the stage is a fine stage.

10. An apparatus comprising:
a stage;
a first actuator, the first actuator being arranged to drive the stage;
a dual actuator arrangement, the dual actuator arrangement being configured to apply at least a first control force to the stage, wherein the dual actuator arrangement includes a first actuator arrangement and a second actuator arrangement; and
a control arrangement, the control arrangement being configured to obtain a frequency associated with the stage and to determine when the frequency is below a threshold frequency, wherein the control arrangement is configured to cause the second actuator arrangement to apply the first control force to the stage when the frequency is below the threshold frequency and to cause the first actuator arrangement to apply the first control force to the stage when the frequency is not below the threshold frequency.

11. The apparatus of claim 10 wherein the second actuator arrangement includes a first EI-core actuator and a second EI-core actuator.

12. The apparatus of claim 11 wherein the first EI-core actuator is configured to apply a force in a first direction and the second EI-core actuator is configured to apply the force in a second direction.

13. The apparatus of claim 10 wherein the second actuator arrangement at least one amplifier and at least one pre-filter.

14. The apparatus of claim 10 wherein the first control force is a feedback control force.

15. The apparatus of claim 11 wherein the control arrangement is further configured to determine whether to cause the feedback control force to be applied on the stage or to cause a feedforward control force to be applied to the stage.

16. The apparatus of claim 15 wherein the first control force is a feedback control force, the control arrangement further being arranged to cause the second actuator arrangement to apply the feedforward control force to the stage when it is determined that the control arrangement is to cause the feedforward control force is to be applied to the stage.

17. The apparatus of claim 16 wherein the control arrangement is arranged to cause the second actuator arrangement to apply the feedforward control force to the stage when the frequency is below the threshold frequency and when the frequency is not below the threshold frequency.

18. The apparatus of claim 10 wherein the first actuator arrangement includes a voice coil motor (VCM) and the second actuator arrangement includes at least one EI-core actuator.

19. The apparatus of claim 10 wherein the stage is a fine stage.

20. The apparatus of claim 19 wherein the frequency is associated with a vibration, the vibration arising when the first actuator drives the stage.

21. A stage apparatus comprising the apparatus of claim 10.

22. An exposure apparatus comprising the stage apparatus of claim 21.

23. A wafer formed using the exposure apparatus of claim 22.
